(19) United States
(12) Patent Application Publication
(10) Pub. No.: US 2013/0107499 A1
(43) Pub. Date: May 2, 2013

(54) KNEEPAD CAP

(71) Applicants: Matthew D. Noble, Los Angeles, CA (US); Steven V. Shelburne, San Marino, CA (US); Roland Jonnathan Uyloan Ecarma, Pasadena, CA (US)

(72) Inventors: Matthew D. Noble, Los Angeles, CA (US); Steven V. Shelburne, San Marino, CA (US); Roland Jonnathan Uyloan Ecarma, Pasadena, CA (US)

(21) Appl. No.: 13/285,051

(22) Filed: Oct. 31, 2011

(51) Int. Cl. F21V 21/08

(52) U.S. Cl. 362/103

(57) ABSTRACT

A kneepad cap includes a controller attached to a power source. A lighting housing is attached to the controller. A cap portion is attached to the lighting housing.

### BACKGROUND

1. Field

The embodiments relate to kneepads, and in particular to lighted kneepad caps for kneepads.

2. Description of the Related Art

Protective kneepads are used by in many different fields for protection or to provide comfort to individuals. For example, kneepads are used when kneeling on hard or rough surfaces or to reduce blunt force trauma. Various kneepad constructions are available and typically comprise a rigid case or padding which is fitted over the knee and held in place by various attachment elements.

### SUMMARY

One embodiment provides a kneepad cap including a controller attached to a power source. A lighting housing is attached to the controller. A cap portion is attached to the lighting housing.

Another embodiment provides a kneepad cap for a kneepad. The kneepad cap includes a switch coupled to a power source. A plurality of lighting elements are coupled to the switch. A cap portion coupled to the lighting element.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates a perspective view of an embodiment of a kneepad cap;

FIG. 2 illustrates a front view of an isolated lighting housing according to one embodiment of the invention;

FIG. 3 illustrates a rear view of the embodiment illustrated in FIG. 1;

FIG. 4 illustrates a side view of the embodiment illustrated in FIG. 1;

FIG. 5 illustrates a block circuit diagram according to one embodiment of the invention; and

FIG. 6 illustrates a block circuit diagram according to another embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of lighted kneepad caps, as well as operation and/or component parts thereof. While the following description will be described in terms of lighted kneepad caps and kneepads for clarity and to place the invention in context, it should be kept in mind that the teachings herein may have broad application to all types of systems, devices and applications.

One embodiment of the invention provides a kneepad cap including a controller attached to a power source. A lighting housing is attached to the controller. A cap portion is attached to the lighting housing. The lighted kneepad cap provides a light source for multiple uses in unlit or dark situations for: safety purposes for road workers, police agencies, towing personnel, rescue workers, location and identification of team members (e.g., for airport personnel, shipping personnel, team sports/entertainment, etc.), construction worker location and identification, etc.

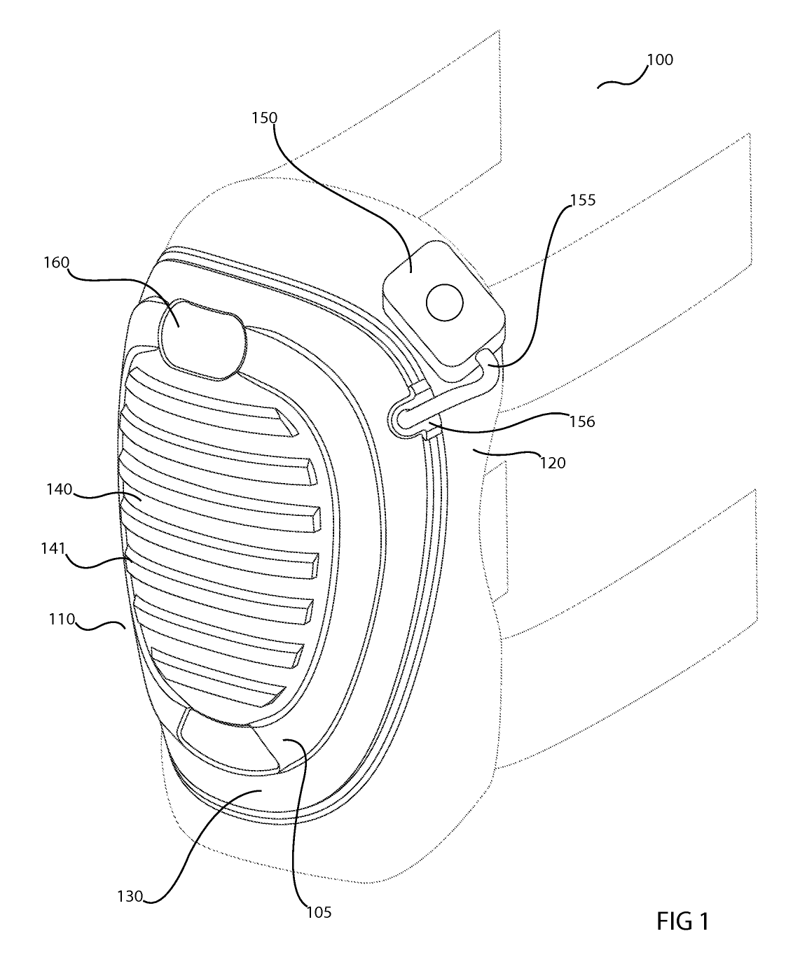

FIG. 1 illustrates a perspective view of one embodiment of a kneepad system 100 including kneepad cap 110 and a kneepad 120 including attachment, cushioning and strapping elements. In one embodiment of the invention, the kneepad cap 110 includes an outer portion 130, a center portion 140 and an inner portion 105. In one embodiment of the invention, the outer portion 130, the center portion 140, and the inner portion 105 are integrally molded as a single device.

In one embodiment of the invention, the kneepad cap 110 further includes a lighting element controller 150 coupled with a wiring conduit 155 and a wiring conduit coupler 156. In one example, the kneepad cap 110 is attached to the kneepad 120 via stitching within a molded perimeter groove or channel. The molded groove or channel where the stitching attaches the kneepad cap 110 to an outer surface of kneepad 120 protects the stitching from abrasion for longer product life.

In one embodiment of the invention, the center portion 140 includes multiple raised protective portions 141, where a channel is formed between adjacent raised protective portions 141. The raised protective portions 141 provide added protection to a user as well as a gripping area for added friction on a surface (e.g., the ground or other surfaces) for preventing slipping/sliding. In one embodiment of the invention, the kneepad cap 110 includes an upper recessed portion 160. In one example, the upper recessed portion 160 provides for placement of a company logo or design, placement of radio frequency identification (RFID) elements for retail inventory and security purposes, etc.

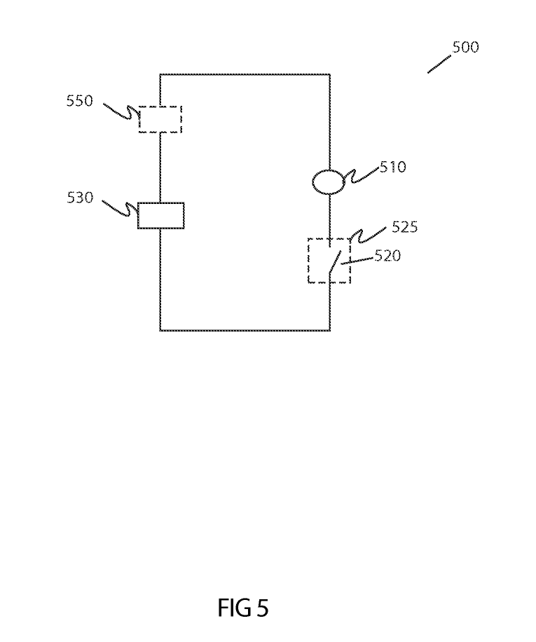

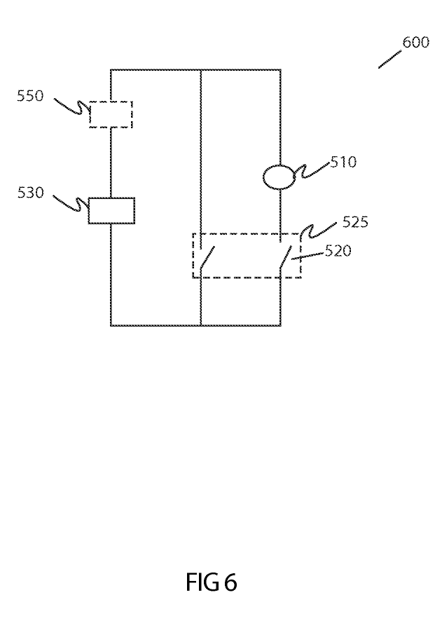

In one example, the controller 150 may be attached to the kneepad 120 via molding, welding, adhesives, stitching, snap-fitting, slide-fitting, etc. In one embodiment of the invention, the controller 150 may be incorporated or embedded within the kneepad cap (not shown). In another embodiment of the invention, the controller 150 may be detached from the kneepad 120. In one embodiment of the invention, the controller 150 may remotely control lighting elements 510 (FIG. 5/FIG. 6) via a radio frequency remote control, infrared remote control, etc. In one example, the controller 150 includes push buttons (not shown) or other toggle elements (not shown) for controlling different functions of the controller, such as turning on/off lighting elements 510, selecting type of lighting (e.g., solid lighting, strobe lighting, color selection, etc.), etc.

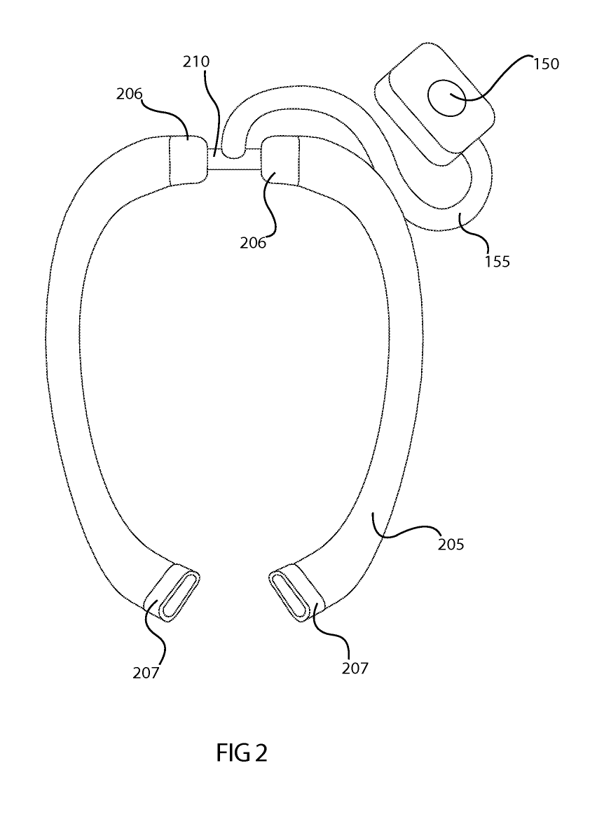

In one example, the wiring conduit 155 may be made of vinyl covered spring steel and be flexible/bendable to rotate or move the controller 150 as desired. In one embodiment of the invention, the wiring conduit 155 may include threads for attaching to the controller 150 and to the multi-way connector 210 (FIG. 2). In other embodiments of the invention, the wiring conduit 155 may be permanently attached to the controller 150 and the multi-way connector 210.

In one embodiment of the invention, the kneepad cap 110 is made of molded polyurethane. In other embodiments of the invention, the kneepad cap 105 may be made of other similar materials to polyurethane. In one example, gel materials may be employed along with the kneepad cap 110 for additional comfort.

In one embodiment of the invention, the kneepad cap 110 includes one or more portions of translucent material for passing light through from the lighting elements 510. In one example, one or more of the outer portion 130, the center portion 140 and the inner portion 105 are made of translucent or semi-translucent material. In another example, the inner portion 105 is made of translucent, clear or semi-clear material and one or more of the outer portion 130 and the center portion 140 includes a high-visibility, reflective or glow in the dark material to enhance the effect of emitted light from the lighting elements 510.

FIG. 2 illustrates a front view of an isolated lighting housing for the kneepad cap 110 according to one embodiment of the invention. In one embodiment of the invention, the lighting housing includes lighting element housings 205 that are connected to a multi-way connector 210. In one example, the lighting element housings are tubes that act as lenses for lighting elements 510 (FIG. 5/FIG. 6). In one example, the multi-way connector connects to the wiring conduit 155 and both lighting element housings 205. In one embodiment of the invention, the lighting element housings 205 include upper end portions 206 and lower end portions 207. In one example, the upper end portions 206 are formed to connect integrally with the multi-way connector 210. In another example, the lower end portions 207 are protective to prevent moisture from entering the lighting element housings 205. In another example, the lower end portions 207 may be solid to prevent light being emitted through the bottom of the lighting element housings 205. In one example, the lower end portions 207 have a purpose of adding structural strength to the lighting element housings 205.

In one example, the lighting element housings 205 are translucent and may be clear, semi-clear, colored, etc. In another example, if a specific color is desired either the lighting element housings 205 or the lighting elements 510 (FIG. 5/FIG. 6) may be the same color or may be colored differently.

In one example, the lighting element housings 205 are made of protective material in order to protect the lighting elements 510 disposed within the lighting element housings 205. In one example, the lighting element housings 205 are made of a cushioned material, such as polyurethane, plastics, rubber, etc. In other examples, the lighting element housings 205 are made of a hardened material (e.g., hardened plastic, rubber, etc., or a combination of a hardened material and cushioned material.

In one embodiment of the invention, the controller 150 includes a protective housing to protect internal components from shock and abrasion. In one embodiment of the invention, the wiring conduit 155 includes a protective material to protect internal wires from compression and abrasion from normal use. It should be noted that other known equivalent materials may be used for the lighting element housings 205, controller housing, wiring conduit 155, multi-way connector 206, include upper end portions 206 and lower end portions 207, such as high-density polyethylene, nylon material, hardened plastic, polymer, rubber, composite material, metal or metal alloy, etc.

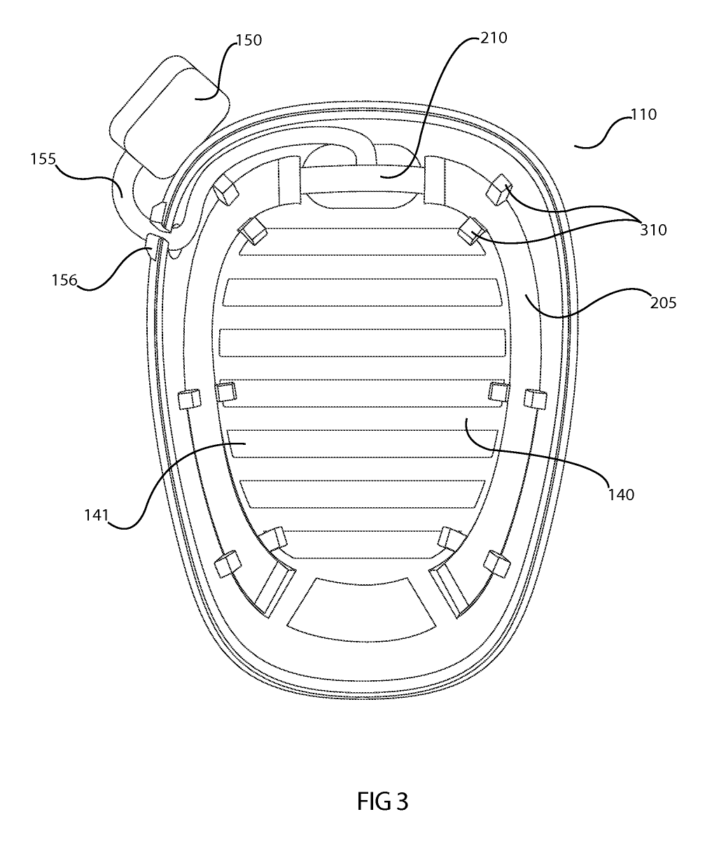

FIG. 3 illustrates a rear view of the kneepad cap 110 according to one embodiment of the invention. In one embodiment of the invention, the rear portion of the kneepad cap 110 includes formed holders 310 for holding the lighting element housings 205 in place when mounted to the rear of the kneepad cap 110. In one embodiment of the invention, the formed holders 310 include pairs of resilient extensions that may be spread apart for placement of the lighting element housings 205 and that return to at or near the original position for locking or holding the lighting element housings 205 in place. In one example, the pairs of resilient extensions forming the formed holders 310 are displaced from one another based at different placements in order to hold the associated different portions of the lighting element housings 205 based on width to be held in place.

In one example, the wiring conduit 155 is pressed into the wiring conduit coupler 156, which is either molded into the kneepad cap 110 or added as a separate component and placed into an opening on the kneepad cap 110. In one example, the wiring conduit 155 is formed in a pseudo “S” curve in order to fit in the form of the rear of the kneepad cap 110 above the left side of the lighting element housings 205.

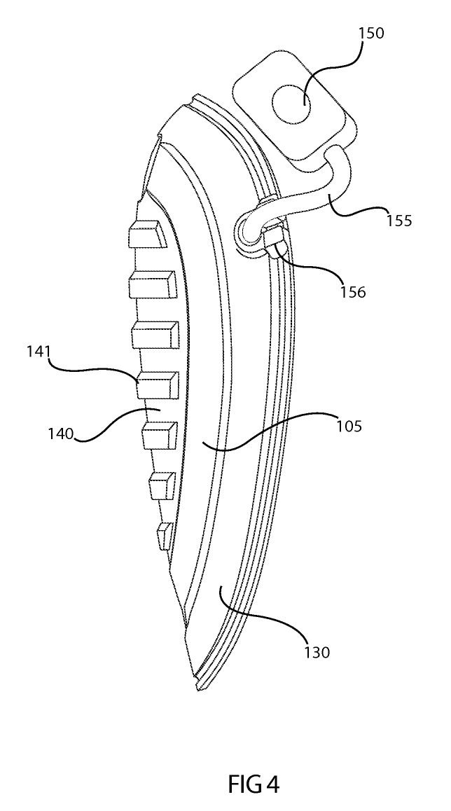

FIG. 4 illustrates a left side view of the kneepad cap 110 according to one embodiment of the invention. As illustrated, the kneepad 110 has a radius of curvature in order to fit on a kneepad 120 to add comfort to a user. The raised protective portions 141 curve around the face of the kneepad cap 110 and provide added height of protection.

FIG. 5 illustrates a circuit 500 for the lighting of the kneepad cap 110 according to one embodiment of the invention. In one embodiment of the invention, the circuit 500 for the lighting source of the kneepad cap 110 includes the lighting element 510, a switch 520 included in or operated by the controller 150, a power source 530 and optional sensor 550. In one example, the switch 520 may comprise a slide switch, a push button switch, a touch switch, remote control switch, etc. In one example, the switch 520 is switched from the sides of the controller 150 adjacent to the wiring conduit 155 that is attached to the controller 155.

In one embodiment of the invention, the lighting element 510 includes multiple light emitting diodes (LEDs) that emit lighting from within the lighting element housings 205. In one example, the LEDs of the lighting element 510 may comprise any combination of colored lighting, such as white, red, green, blue, yellow, infrared, etc. In other examples, other types of light sources may be employed with lighting element 510, such as Electroluminescent (EL) light sources, etc. In one example, the multiple LEDs may be connected in series, parallel or both.

In one embodiment of the invention, the switch 520 may comprise a user lighting selection functionality for controlling a desired light intensity from the lighting element 510 by means of a controller circuit 525. In one example, the switch 520 and controller circuit 525 may be user selectable to light only a portion of LEDs of the lighting element 510 (e.g., one, two, three, all, etc.). In another example, the switch 520 and controller circuit 525 may be user selectable to select a particular color of LEDs of the lighting element 510 (e.g., white, red, green, blue, yellow, etc.). In yet another example, the switch 520 and controller circuit 525 may be user selectable to select solid or blinking/strobe LEDs of the lighting element 510.

In one example, the sensor 550 may comprise a position determining sensor (e.g., laying flat or vertical), a light sensor, or any combination of various sensors to provide control of the switch 520. In one example, upon employing a position determining sensor as sensor 550, moving the kneepad cap 110 (e.g., a positioning the kneepad cap 110 from a horizontal position to a vertical or bent position) closes the switch 520, which provides voltage to the lighting element 510 from power source 530, and moving the kneepad cap 110 back to a horizontal position opens the switch 520 cutting off voltage from the power source 530 to the lighting element 510. In this example, power may be saved by turning off the lighting element 510 when the kneepad cap 110 would be on a surface and the emitted light would otherwise be emitted downward.

In one example, upon employing a light sensor as sensor 550, when the switch 520 is placed in an on position, the sensor 550 will not close the circuit 500 unless the sensor 550 senses that not enough light is within the proximity of the light sensor (i.e., the area is dark enough to necessitate lighting the area). In one example, the light sensor 550 may be positioned on the sides, front or back portions of the controller 150. In one example, employing the light sensor 550 provides energy saving when lighting the lighting source 510 is not necessary based on available ambient light. In one example, the light sensor 550 may be manually overridden. In one example, the sensor 550 may include any combination of sensors, such as motion and light sensors, position and light sensors, etc.

In one embodiment of the invention, the power source 530 comprises one or more rechargeable or non-rechargeable batteries selected based on the number of LEDs and/or voltage required to power the lighting element 510. In one example, a solar charging circuit is employed to store energy in a rechargeable battery of power source 530. In one example, the solar charging circuit may be disposed on the outer portion of the controller 150. In another example, an adapter or plug in socket may be employed with the lighting source circuit 500 to connect to an external power source, such as a battery pack from an electric tool (e.g., electric drill, hammer, screwdriver, etc.), separate additional battery pack, an AC/DC power supply, etc. Other examples may include multiple power sources 530 for extended lighting.

FIG. 6 illustrates a circuit 600 for the lighting of the kneepad cap 110 according to one embodiment of the invention. Circuit 600 is similar to circuit 500 except multiple switches and multiple lighting elements 510 1-N are employed, where N is a positive integer. In one example, the controller circuit 525 controls switches 520 1-N, where N is a positive number. In this example, the switches 520 1-N control whether power from the power source 530 is supplied to the lighting elements 510, where a number of lighting elements 510 may be employed, such as two, three, four, etc. In one example, a user that is part of a first team that is recognized with a first color would switch on lighting elements 510 with the specific color of the team. A next time the user uses a kneepad 120 with kneepad cap 110, they may be part of a team associated with a different color, therefore, the circuit 600 may be used to select the other lighting element 510 with the required color. Other examples include identifying a particular rank of an individual based on a desired color selected with the switches 520. Another example may include a particular pattern of colors or lights that may be selected. Yet another example may be switching to a different lighting element 510 based on an LED failure. In one example, multiple power sources 530 may be associated with particular switches 520.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A kneepad cap comprising:
a controller coupled to a power source;
a lighting housing coupled to the controller; and
a cap portion coupled to the lighting housing.

2. The kneepad cap of claim 1, wherein the lighting housing includes a plurality of lighting elements, and the plurality of lighting elements emit light through the cap portion.

3. The kneepad cap of claim 1, wherein the controller comprises a multi-position switch coupled to the power source.

4. The kneepad cap of claim 3, wherein the multi-position switch includes a setting for solid and flashing light.

5. The kneepad cap of claim 3, wherein the cap portion includes a wiring conduit coupling element.

6. The kneepad cap of claim 3, wherein the cap portion comprises:
an outer portion;
a center portion; and
an inner portion.

7. The kneepad cap of claim 6, wherein the center portion is translucent.

8. The kneepad cap of claim 6, wherein the inner portion is translucent.

9. The kneepad cap of claim 6, wherein the center portion includes a plurality of raised elements.

10. The kneepad cap of claim 6, wherein the cap portion further includes a first recessed portion positioned on an upper portion of the cap portion.

11. The kneepad cap of claim 1, wherein the controller is coupled to a kneepad attached to the cap portion.

12. The kneepad cap of claim 1, wherein the lighting housing comprises:
a tube coupling portion;
a first tube portion coupled to a first portion of the coupling tube portion; and
a second tube portion coupled to a second portion of the coupling tube portion.

13. The kneepad cap of claim 12, wherein the first tube portion and the second tube portion each include a portion of the plurality of lighting elements.

14. The kneepad cap of claim 12, wherein the controller selectively controls the plurality of lighting elements.

15. A kneepad cap for a kneepad, the kneepad cap comprising:
a switch coupled to a power source;
a plurality of lighting elements coupled to the switch; and
a cap portion coupled to the lighting element.

16. The kneepad cap of claim 15, wherein the cap portion further comprising:
a wiring conduit coupling element;
an outer portion;
a center portion including a plurality of raised elements; and
an inner portion.

17. The kneepad cap of claim 15, wherein at least a portion of the cap portion is translucent.

18. The kneepad cap of claim 16, wherein the switch is coupled to a kneepad attached to the cap portion.

19. The kneepad cap of claim 1, further comprising a lighting housing including:
a tube coupling portion;
a first tube portion coupled to a first portion of the coupling tube portion; and
a second tube portion coupled to a second portion of the coupling tube portion, wherein the first tube portion and the second tube portion each include a portion of the plurality of lighting elements.

20. The kneepad cap of claim 19, wherein the switch includes a plurality of settings for controlling the plurality of lighting elements.
